(19) United States
(12) Patent Application Publication
(10) Pub. No.: US 2026/0028453 A1
(43) Pub. Date: Jan. 29, 2026

(54) FLUOROSILICONE RAW RUBBER WITH HIGH ISOTACTICITY AND PREPARATION METHOD THEREFOR, AND HIGH-STRENGTH OIL-RESISTANT FLUOROSILICONE SEALING MATERIAL FOR ENGINE AND PREPARATION METHOD THEREFOR

(71) Applicant: SHANDONG UNIVERSITY, Jinan (CN)

(72) Inventors: Hua WANG, Jinan (CN); Ruirui SHI, Jinan (CN); Chuanjian ZHOU, Jinan (CN)

(73) Assignee: SHANDONG UNIVERSITY, Jinan (CN)

(21) Appl. No.: 18/994,066

(22) PCT Filed: Jul. 6, 2023
(86) PCT No.: PCT/CN2023/106158

§ 371 Date: Jan. 14, 2025

(30) Foreign Application Priority Data
Jan. 10, 2023 (CN) 202310033652.4
Jan. 10, 2023 (CN) 202310038317.3

(51) Int. Cl. C08G 77/24; C08G 77/08; C08G 77/18; C08J 3/20; C08J 3/24; C08K 3/22; C08K 3/36; C08L 83/08

(52) U.S. Cl. CPC C08G 77/24; C08G 77/08; C08G 77/18; C08J 3/203; C08J 3/244; C08J 3/247; C08K 3/22; C08K 3/36; C08L 83/08; C08G 2190/00; C08L 2205/08

(57) ABSTRACT

A fluorosilicone raw rubber with high isotacticity is provided. In the fluorosilicone raw rubber with high isotacticity, the content of a cis-methyl trifluoropropyl siloxane structure is not less than 20%, and the content of a vinyl siloxane chain link is 0-50%. Compared with traditional fluorosilicone raw rubber, the fluorosilicone raw rubber with high isotacticity prepared by the present disclosure has a higher degree of isotacticity in a molecular chain structure thereof; accordingly, a self-enhancing effect can be obtained by producing microcrystalline particles by means of strain-induced crystallization during stretching of cis fluorosilicone rubber, thereby greatly improving the mechanical properties of fluorosilicone rubber.

### CROSS REFERENCE TO THE RELATED APPLICATIONS

This application is the national phase entry of International Application No. PCT/CN2023/106158, filed on Jul. 6, 2023, which is based upon and claims priority to Chinese Patent Application No. 202310033652.4, filed on Jan. 10, 2023, and to Chinese Patent Application No. 202310038317.3, filed on Jan. 10, 2023, the entire contents of which are incorporated herein by reference.

### TECHNICAL FIELD

The present disclosure relates to the field of rubber materials, in particular to fluorosilicone raw rubber with high isotacticity and a preparation method therefor, and a high-strength oil-resistant fluorosilicone sealing material for an engine and a preparation method therefor.

### BACKGROUND

In recent years, with development of the fields of aerospace, the automobile industry and the like towards high performance and long service life, materials for making a sealing ring, such as nitrile rubber, natural rubber, ethylene propylene rubber, fluororubber and various universal sealing rubber, are poor in weather resistance though they have high mechanical properties and cannot meet use under extreme conditions and thus limit service time of many devices.

Fluorosilicone rubber is special silicone rubber using methyl trifluoropropyl siloxane as a main link, overcomes a drawback of poor weather resistance of a conventional sealing material while it has excellent solvent resistance and oil resistance and thus gradually becomes one of mainest medium-resistant sealing materials in the fields of aerospace, the automobile industry, etc. A monomer for preparing the fluorosilicone raw rubber is 1,3,5-tris-(3,3,3-trifluoropropyl)methylcyclotrisiloxane (D₃F), a current monomer for preparing conventional fluorosilicone raw rubber mainly uses trans-1,3,5-tris-(3,3,3-trifluoropropyl)methylcyclotrisiloxane (trans-D₃F), a space structure of a molecular chain of the fluorosilicone raw rubber is an atactic structure and cannot play a role in stretching and self-enhancing, which leads to low mechanical properties of current fluorosilicone rubber and cannot meet the requirements in the fields of aerospace, etc.

A patent CN107141480B discloses fluorosilicone raw rubber with high anti-swelling property and a preparation method therefor, every 100 parts, by mass, of raw rubber include, by mass, 10 parts to 90 parts of a siloxane tricyclic compound containing long-chain fluoroalkyl, 8 parts to 88 parts of a siloxane cyclic compound containing trifluoropropyl, 0.5 parts to 10 parts of a siloxane cyclic compound containing vinyl, 0 part to 8 parts of a siloxane cyclic compound containing no fluorine and double bonds and 0.02 parts to 0.2 parts of an end-capping reagent, and the siloxane tricyclic compound containing long-chain fluoroalkyl may be represented by a formula (Si(CH₃)(R^{f})O)₃, wherein R^{f} may be represented by a formula —(CH₂)ₘCₙF₂ₙ₊₁, n is an integer ranging from 3 to 8, and m is 2 or 3. In this patent, a siloxane cyclic compound containing trifluoropropyl is mainly trans, and does not involve study on fluorosilicone raw rubber with high isotacticity with high isotacticity.

A Chinese patent for invention with publication number CN106280495A discloses a high-strength and high-hardness fluorosilicone rubber composition, including, by mass, the following raw materials: 100 parts of fluorosilicone raw rubber, 35 parts to 65 parts of fumed silica, 3 parts to 7 parts of a heat stabilizer, 0.5 parts to 2.0 parts of a vulcanizing agent and 5 parts to 8 parts of a constitution controller. However, in this patent, the fluorosilicone raw rubber is mainly of a trans-methyl trifluoropropyl siloxane structure and does not involve the study on the fluorosilicone raw rubber with high isotacticity with high isotacticity.

### SUMMARY

An inventor discovers through a study that an existing monomer for preparing the fluorosilicone rubber mainly uses trans-D₃F, which leads to poor mechanical properties. When the fluorosilicone raw rubber with high isotacticity is prepared by using a certain amount of cis-1,3,5-tris-(3,3,3-trifluoropropyl)methylcyclotrisiloxane (cis-D₃F for short), which has a space structure of an isotactic structure and has capability of strain-induced crystallization, the mechanical properties of the fluorosilicone rubber can be greatly improved. The inventor discovers through repeated experiments that the cis-D₃F and the trans-D₃F have quite different reaction rates in a polymerization process, there is a problem that the polymerization process, a molecular weight and space structure distribution are extremely difficult to control in a process for preparing the fluorosilicone raw rubber by using the cis-D₃F as the monomer, there is a strict requirement for reaction conditions, and accurate control over the polymerization process, the molecular weight and the distribution of fluorosilicone raw rubber may be achieved through combination of an initiator and an end-capping reagent.

In one aspect, the present disclosure provides a fluorosilicone raw rubber with high isotacticity, and a structural formula of the fluorosilicone raw rubber with high isotacticity is as follows:

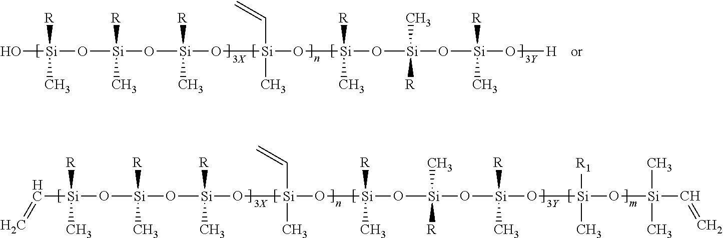

wherein R is trifluoropropyl, R₁ is one or more of phenyl, vinyl and trifluoropropyl, m=2-10, 0<X/(X+Y)<1, and n/(X+Y)=0-10%.

A content of a cis-methyl trifluoropropyl siloxane structure is not less than 20%, and a content of a vinyl siloxane chain link is 0 to 50%.

In another aspect, the present disclosure provides a method for preparing the fluorosilicone raw rubber with high isotacticity, and the preparation method includes:
adding an end-capping reagent, an initiator, a vinyl cyclic and an accelerant into a D₃F whose cis-D₃F has a content not less than 20% for a polymerization reaction, and then adding a neutralizer in sequence for removing volatile components to obtain the fluorosilicone raw rubber with high isotacticity.

A mass ratio of the D₃F to the end-capping reagent to the initiator to the vinyl cyclic to the accelerant to the neutralizer is 10000:(0-100):(1-100):(0-2000):(0-1):(1-100).

According to yet another aspect of the present disclosure, a high-strength oil-resistant fluorosilicone sealing material for an engine is provided, including, by weight, the following raw materials:
100 parts of a fluorosilicone raw rubber with high isotacticity, 5 parts to 60 parts of a reinforcing filler and 0.5 parts to 4 parts of a vulcanizing agent.

A content of a cis-methyl trifluoropropyl siloxane structure in the fluorosilicone raw rubber with high isotacticity is not less than 20%.

Many sealing rings prepared from the fluorosilicone rubber currently on the market cannot meet application thereof under a high load due to low strength though the problems such as aging resistance, heat resistance and low temperature resistance are solved. Thus, during actual use, a sealing ring is usually prepared by mixing with other high-strength rubber, but mixing may lead to problems such as rubber incompatibility and reduction of oil resistance of the sealing ring, and shorten a service life of a sealing material. It is discovered in the study that the fluorosilicone raw rubber with high isotacticity may have an orientation behavior of a molecular chain during a stretching process due to a certain degree of isotacticity, induce crystallization and thus make the fluorosilicone rubber self-reinforcing. Thus, a fluorosilicone rubber product of this structure has better mechanical properties than common fluorosilicone rubber. The oil resistance is better when the sealing ring is prepared by mixing with other high-strength rubber.

In yet another aspect, the present disclosure provides a method for preparing a high-strength oil-resistant fluorosilicone sealing material, including:
uniformly mixing fluorosilicone raw rubber with high isotacticity and a reinforcing filler according to a corresponding ratio, then adding a vulcanizing agent, performing uniform dispersion, and then performing forming through a first-stage vulcanization and a second-stage vulcanization.

A temperature in the first-stage vulcanization ranges from 140° C. to 180° C., and a temperature in the second-stage vulcanization ranges from 140° C. to 220° C.

Compared with the prior art, beneficial effects of the present disclosure include at least one of the following contents.

(1) Compared with the prior art, the fluorosilicone raw rubber with high isotacticity in the present disclosure is fluorosilicone raw rubber having an isotactic space structure, has capability of strain-induced crystallization and can improve the mechanical properties of the fluorosilicone rubber.

(2) Compared with the prior art, the present disclosure designs suitable initiators and capping reagents, and realizes precise control of the cis-D₃F polymerization process and the molecular weight of fluorosilicone raw rubber by strictly controlling conditions such as reaction temperature and time.

(3) Compared with the prior art, the fluorosilicone raw rubber with high isotacticity prepared by the present disclosure may be used for base rubber of the fluorosilicone rubber, and a sealing material with the excellent mechanical properties and suitable for bearing a high load may be obtained by using only the reinforcing filler. For example, the sealing ring.

(4) The fluorosilicone rubber sealing material prepared by using the fluorosilicone raw rubber with high isotacticity in the present disclosure does not need to be mixed with other high-strength rubber for improving its mechanical properties, and meanwhile, its sealing ring has better weather resistance and oil resistance.

(5) The fluorosilicone sealing material prepared by the present disclosure has a simple formula, and good mechanical properties and may bear the high load and be used for a long time under extreme conditions.

(6) The fluorosilicone sealing material prepared by the present disclosure has capability of strain-induced crystallization and may achieve self-enhancing.

### BRIEF DESCRIPTION OF THE DRAWINGS

Accompanying drawings described here are used for providing further understanding for the present disclosure and constitute a part of the present disclosure, and exemplary embodiments of the present disclosure and their descriptions are intended to explain the present disclosure instead of constituting an inappropriate limitation on the present disclosure. In the accompanying drawings:

FIG. 1 shows a nuclear magnetic resonance fluorine spectroscopy of cis-fluorosilicone raw rubber prepared by Embodiment 1 of the present disclosure.

FIG. 2 shows a nuclear magnetic resonance fluorine spectroscopy of common fluorosilicone raw rubber prepared by Comparative Example 1 of the present disclosure.

FIG. 3 shows a polarizing microscope diagram of fluorosilicone raw rubber with high isotacticity prepared by Embodiment 1 of the present disclosure.

FIG. 4 shows a polarizing microscope diagram of common fluorosilicone raw rubber prepared by Comparative Example 1 of the present disclosure.

FIG. 5 shows a nuclear magnetic resonance fluorine spectroscopy of fluorosilicone raw rubber of Embodiment 5 of the present disclosure.

FIG. 6 shows a nuclear magnetic resonance fluorine spectroscopy of fluorosilicone raw rubber of Comparative Example 3.

### DETAILED DESCRIPTION OF THE EMBODIMENTS

In order to more clearly explain the whole concept of the present disclosure, a detailed description is made below with reference to the accompanying drawings of the specification by example.

Many specific details are set forth in the following description to facilitate a full understanding of the present disclosure, but the present disclosure may alternatively be implemented in other manners different from those described herein, and therefore, the protection scope of the present disclosure is not limited by the specific embodiments disclosed below.

Besides, in the description of the present disclosure, it needs to be understood that directions or position relations indicated by terms such as “top”, “bottom”, “inner”, “outer”, “axial”, “radial” and “circumferential” are directions or position relations as shown in the accompanying drawings and are only intended to conveniently describe the present disclosure and concise the description but not to indicate or imply that a referred apparatus or element necessarily has a specific direction or is constructed and operated in a specific direction, so as not to be understood as a limitation on the present disclosure.

In the present disclosure, unless otherwise specified and limited clearly, terms such as “mount”, “connect”, “connection” and “fix” are to be understood in a broad sense, for example, it may be fixed connection, or detachable connection or integrated; it may be mechanical connection, electrical connection or communication; it may be direct connection, indirect connection through an intermediate medium, communication between interiors of two elements, or an interactive relation between the two elements. Specific meanings of the above terms in the present disclosure may be understood by those ordinarily skilled in the art according to specific conditions.

In the present disclosure, unless otherwise specified and limited clearly, a first feature being “on” or “below” a second feature may be that the first feature is in direct contact with the second feature, or that the first feature is in indirect contact with the second feature through an intermediate medium. In the description of the specification, a description with reference to terms such as “one embodiment”, “some embodiments”, “example”, “specific example” or “some examples” means that a specific feature, structure, material or characteristic described with reference to the embodiment or example is included in at least one embodiment or example of the present disclosure. In the present specification, a schematic statement for the above terms is not necessarily for the same embodiment or example. Besides, the described specific features, structures, materials or characteristics may be combined in any one or more embodiments or examples in a proper manner.

In an exemplary embodiment of the present disclosure, a structural formula of fluorosilicone raw rubber with high isotacticity is as follows:

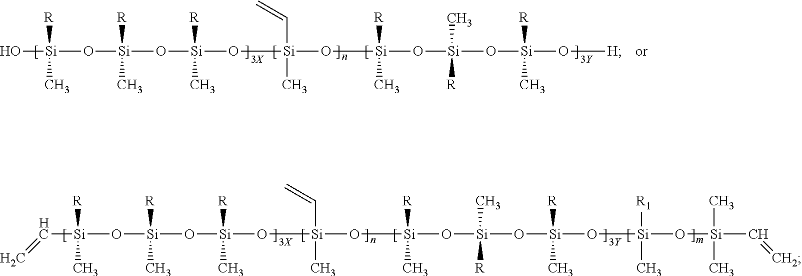

wherein R is trifluoropropyl, R₁ is one or more of phenyl, vinyl and trifluoropropyl, m is 2-10, 0<X/(X+Y)<1, and n/(X+Y)=0-10%.

A content of a cis-methyl trifluoropropyl siloxane structure is not less than 20%, and a content of a vinyl siloxane chain link is 0 to 50%.

In the present disclosure, a structure formed by connecting three or more than three methyl trifluoropropyl siloxane chain links with the same spatial configuration is called the cis-methyl trifluoropropyl siloxane structure. The content of the cis-methyl trifluoropropyl siloxane structure refers to a proportion for which the cis-methyl trifluoropropyl siloxane structure accounts of a whole fluorosilicone raw rubber molecular chain, and the content of the vinyl siloxane chain link refers to a proportion for which the vinyl siloxane chain link accounts of the whole fluorosilicone raw rubber molecular chain.

Further, the m ranges from 4 to 8, and preferably, the m ranges from 5 to 7.

Further, 0.2<X/(X+Y)<0.8, and preferably, 0.3<X/(X+Y)<0.6.

Further, n/(X+Y)=2% to 8%, and preferably, n/(X+Y)=3% to 6%.

Further, the content of the cis-methyl trifluoropropyl siloxane structure is not less than 30%; preferably, the content of the cis-methyl trifluoropropyl siloxane structure is not less than 50%; and more preferably, the content of the cis-methyl trifluoropropyl siloxane structure is not less than 80%.

Further, a molecular weight of the fluorosilicone raw rubber with high isotacticity is not less than 1,000; and preferably, the molecular weight ranges from 200,000 to 2,000,000.

Further, the content of the vinyl siloxane chain link of the fluorosilicone raw rubber with high isotacticity ranges from 10% to 40%; and preferably, the content of the vinyl siloxane chain link ranges from 20% to 30%.

In another exemplary embodiment of the present disclosure, a method for preparing fluorosilicone raw rubber with high isotacticity includes:
adding an end-capping reagent, an initiator, a vinyl cyclic and an accelerant into D₃F whose cis-D₃F has a content not less than 20% for a polymerization reaction, and then adding a neutralizer in sequence for removing volatile components to obtain the fluorosilicone raw rubber with high isotacticity.

A mass ratio of the D₃F to the end-capping reagent to the initiator to the vinyl cyclic to the accelerant to the neutralizer is 10000:(1-100):(1-100):(0-2000):(0-1):(1-100). Further, a mass ration of the D₃F to the end-capping reagent to the initiator to the vinyl cyclic to the accelerant to the neutralizer is 10000:(20-80):(20-80):(20-1000):(0-1):(2-50).

In a cyclic mixture containing cis-D₃F and trans-D₃F, further, the content of the cis-D₃F is not less than 30%; preferably, the content of the cis-D₃F is not less than 50%; and more preferably, the content of the cis-D₃F is not less than 80%. A structural formula of the cis-D₃F is shown as follows:

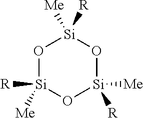

wherein R is trifluoropropyl.

Specific steps of the method for preparing the fluorosilicone raw rubber with high isotacticity are:

(1) water in a reactant of a siloxane cyclic, a vinyl end-capping reagent and an alkali metal catalyst is removed under vacuum, a temperature increases to a range from 60° C. to 120° C., a reaction is performed for 1 h to 3 h, and then unreacted small molecules and by-product are removed by decompression to obtain the end-capping reagent. A mass ratio of the siloxane cyclic to the vinyl end-capping reagent to the alkali metal catalyst is 2500:(650-1500):(1-2). Preferably, a reaction temperature ranges from 80° C. to 100° C. The end-capping reagent prepared by the present disclosure may control the molecular weight and further improve mechanical properties.

(2) An alkali metal hydroxide or a basic hydroxide and a siloxane cyclic are mixed, then dehydrated, heated to a range from 80° C. to 180° C. and reacted for 0.5 h to 2 h, and then volatile components are removed by decompression to obtain the initiator. A mass ratio of the alkali metal hydroxide or the basic hydroxide to the siloxane cyclic is (0.1-10):100, and preferably, a mass ratio of the alkali metal hydroxide or the basic hydroxide to the siloxane cyclic is (2-8):100. A reaction temperature ranges from 120° C. to 150° C. The initiator may avoid occurrence of a side reaction during a polymerization process, improve the content of the cis-methyl trifluoropropyl siloxane structure in a polymerization product, and thus improve the mechanical properties.

End-capping effects are different due to different activities of the end-capping reagent and different boiling points. For example, an end-capping effect of a polymerization system is poor if a common vinyl end-capping reagent is used alone, which thus affects the mechanical properties of the fluorosilicone rubber with high isotacticity. In order to guarantee a high end-capping rate and molecular weight, in the present disclosure, by combination of the end-capping reagent and the initiator, the fluorosilicone rubber with an isotactic space structure and good mechanical properties is prepared.

(3) A cyclic containing a certain percentage of cis-D₃F is dehydrated under vacuum, the end-capping reagent, the initiator, the vinyl cyclic and the accelerant obtained in steps (1) and (2) are added, and a polymerization reaction is performed for 0.5 h to 6 h in 40° C. to 180° C. Further, a reaction temperature in the polymerization reaction ranges from 50° C. to 160° C.; preferably, the reaction temperature ranges from 80° C. to 180° C.; and more preferably, the temperature in the polymerization reaction ranges from 110° C. to 150° C. The vinyl cyclic may be a cyclic mixture of trimethyl trivinyl cyclotrisiloxane, tetramethyl tetravinyl cyclotetrasiloxane and a methyl vinyl and methyl trifluoropropyl. The accelerant may be one of tetrahydrofuran, dimethylsulfoxide and dioxane.

(4) An appropriate amount of neutralizer is added in a product obtained in step (3), stirring is performed, and then volatile components are removed by decompression in a high temperature to obtain the cis-fluorosilicone raw rubber. The neutralizer may be one or more of formic acid, acetic acid, silica-based phosphate, fluorosilicone-based phosphate or CO₂.

The siloxane cyclic may be one or more of methyl phenyl cyclosiloxane, a diphenyl cyclic, a dimethyl cyclic, a diethyl cyclic, methyl vinyl cyclosiloxane and methyl trifluoropropyl siloxane.

The alkali metal hydroxide or the basic hydroxide used in the initiator may be one of tetramethylammonium hydroxide, tetraethylammonium hydroxide, potassium hydroxide, sodium hydroxide and lithium hydroxide.

### Embodiment 1

Fluorosilicone raw rubber with high isotacticity with a molecular weight being 600,000, a vinyl content being 0.5% and a content of a cis-methyl trifluoropropyl siloxane structure being 70% is prepared. A specific preparation method is:

(1) preparation of an end-capping reagent: water in a reactant of 500 g of a methyl phenyl siloxane cyclic, 150 g of a vinyl end-capping reagent and 0.2 g of an alkali metal catalyst, namely potassium is removed under vacuum, a temperature increases to 60° C. for a reaction for 1 h, and then unreacted small molecules and by-product are removed by decompression to obtain the end-capping reagent. A mass ratio of the siloxane cyclic to the vinyl end-capping reagent to the alkali metal catalyst is 2500:750:1.

(2) Preparation of an initiator: 100 g of a siloxane cyclic, namely methyl phenyl cyclosiloxane and 1 g of potassium hydroxide are heated and dehydrated under vacuum, a temperature increases to 120° C. for a reaction for 1 h, and unreacted small molecules and by-product are removed by decompression to obtain the initiator. A mass ratio of the potassium hydroxide to the methyl phenyl cyclosiloxane is 1:100.

(3) Preparation of the fluorosilicone raw rubber with high isotacticity: 20 kg of a cyclic mixture containing 70% of cis-D₃F is added into a reacting kettle, and dehydrated for 1 h under vacuum, 60 g of a vinyl cyclic, namely trimethyl trivinyl cyclotrisiloxane, 2 g of an accelerant, 50 g of the end-capping reagent and 50 g of the initiator are added, a temperature increases to 150° C., polymerization is started, system viscosity starts to increase, and a reaction is performed for 1 h. Then 5 g of acetic acid is added for neutralization for 1 h, and unreacted small molecules and by-product are removed under vacuum. A mass ratio of the D₃F to the end-capping reagent to the initiator to the vinyl cyclic to the accelerant to the neutralizer is 10000:25:25:30:1:2.5, and the cis-fluorosilicone raw rubber with the molecular weight being 600,000 is obtained, a structural formula of which is as follows:

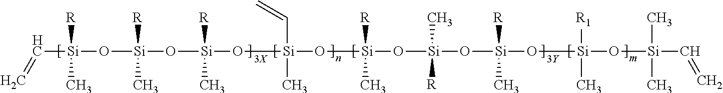

wherein R is trifluoropropyl, R₁ is phenyl, and n/(X+Y+m+n)=0.5%.

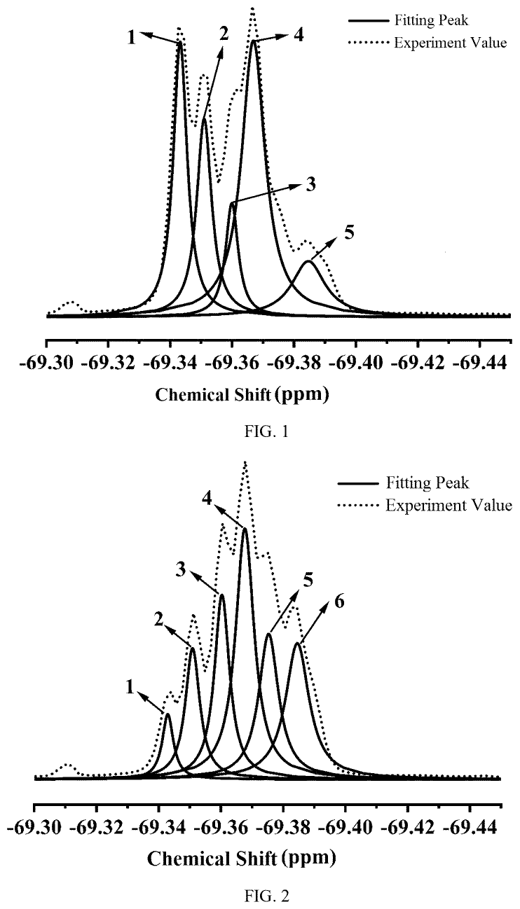

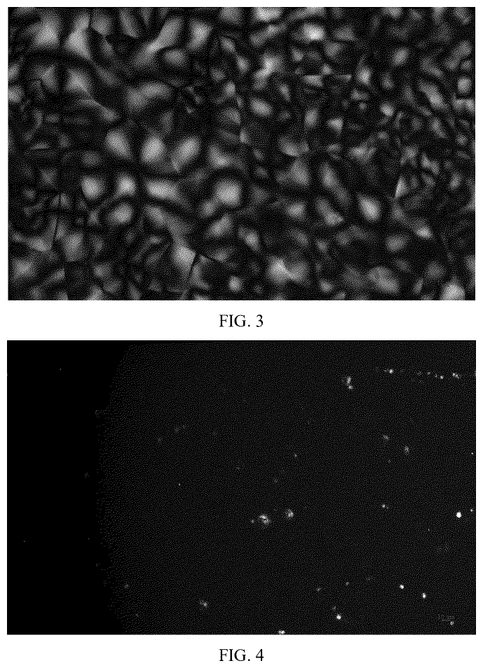

A nuclear magnetic resonance fluorine spectroscopy of the cis-fluorosilicone raw rubber prepared by Embodiment 1 is shown in FIG. 1, a polarizing microscope picture is shown in FIG. 3, and it may be seen that the polarizing microscope picture of the polymer presents a typical phenomenon of Maltese cross extinction, which shows that the cis-fluorosilicone raw rubber is crystallized cis-fluorosilicone raw rubber.

### Embodiment 2

Fluorosilicone raw rubber with high isotacticity with a molecular weight being 1,000,000, a vinyl content being 0.5% and a content of a cis-methyl trifluoropropyl siloxane structure being 70% is prepared. A specific preparation method is:

(1) preparation of an end-capping reagent: water in a reactant of 500 g of a diphenyl siloxane cyclic, 200 g of a vinyl end-capping reagent and 0.4 g of an alkali metal catalyst, namely rubidium is removed under vacuum, a temperature increases to 65° C. for a reaction for 1 h, and then unreacted small molecules and by-product are removed by decompression to obtain the end-capping reagent. A mass ratio of the siloxane cyclic to the vinyl end-capping reagent to the alkali metal catalyst is 2500:1000:2.

(2) Preparation of an initiator: 100 g of a diphenyl siloxane cyclic and 0.8 g of sodium hydroxide are heated and dehydrated under vacuum, a temperature increases to 120° C. for a reaction for 1 h, and unreacted small molecules and by-product are removed by decompression to obtain the initiator. A mass ratio of the sodium hydroxide to the diphenyl siloxane cyclic is 0.8:100.

(3) Preparation of the fluorosilicone raw rubber with high isotacticity: 20 kg of a cyclic mixture containing 70% of cis-D₃F is added into a reacting kettle, and dehydrated for 1 h under vacuum, 60 g of a vinyl cyclic, namely trimethyl trivinyl cyclotetrasiloxane, 2 g of an accelerant, 20 g of the end-capping reagent and 30 g of the initiator are added, a temperature increases to 140° C., polymerization is started, system viscosity starts to increase, and a reaction is performed for 2 h. Then 3 g of acetic acid is added for neutralization for 1 h, and unreacted small molecules and by-product are removed under vacuum. A mass ratio of the D₃F to the end-capping reagent to the initiator to the vinyl cyclic to the accelerant to the neutralizer is 10000:10:15:30:1:1.5, and the cis-fluorosilicone raw rubber with the molecular weight being 1,000,000 may be obtained, a structural formula of which is as follows:

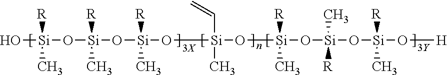

wherein R is trifluoropropyl, and n/(X+Y+n)=0.5%.

### Embodiment 3

Fluorosilicone raw rubber with high isotacticity with a molecular weight being 1,000,000, a vinyl content being 0.5% and a content of a cis-methyl trifluoropropyl siloxane structure being 100% is prepared.

(1) Preparation of an end-capping reagent: water in a reactant of 500 g of a dimethyl cyclic, 200 g of a vinyl end-capping reagent and 0.4 g of an alkali metal catalyst, namely potassium is removed under vacuum, a temperature increases to 70° C. for a reaction for 1 h, and then unreacted small molecules and by-product are removed by decompression to obtain the end-capping reagent. A mass ratio of the siloxane cyclic to the vinyl end-capping reagent to the alkali metal catalyst is 2500:1000:2.

(2) Preparation of an initiator: 100 g of a dimethyl cyclic and 2 g of potassium hydroxide are heated and dehydrated under vacuum, a temperature increases to 120° C. for a reaction for 1 h, and unreacted small molecules and by-product are removed by decompression to obtain the initiator. A mass ratio of the potassium hydroxide to the dimethyl cyclic is 2:100.

(3) Preparation of the fluorosilicone raw rubber with high isotacticity: 20 kg of a cyclic containing 100% cis-D₃F is added into a reacting kettle, and dehydrated for 1 h under vacuum, 60 g of a vinyl cyclic, 1 g of an accelerant, 20 g of the end-capping reagent and 15 g of the initiator are added, a temperature increases to 115° C., polymerization is started, system viscosity starts to increase, and a reaction is performed for 1.5 h. Then 3 g of acetic acid is added for neutralization for 2 h, and unreacted small molecules and by-product are removed under vacuum. A mass ratio of the D₃F to the end-capping reagent to the initiator to the vinyl cyclic to the accelerant to the neutralizer is 10000:10:7.5:30:0.5:1.5. The cis-fluorosilicone raw rubber with the molecular weight being 1,000,000 may be obtained, a structural formula of which is as follows:

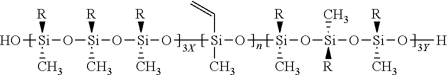

wherein R is trifluoropropyl, and n/(X+Y+n)=0.5%.

### Embodiment 4

Based on Embodiment 1, fluorosilicone raw rubber with high isotacticity with a molecular weight being 1,000,000, a vinyl content being 0.5% and a content of a cis-methyl trifluoropropyl siloxane structure being 20% is prepared.

### Comparative Example 1

Based on Embodiment 2, a difference is that a molecular weight of trans-fluorosilicone raw rubber prepared from 100% of trans-D₃F is 1,000,000, a vinyl content is 0.5%, a nuclear magnetic fluorine spectroscopy is shown in FIG. 2, and a polarizing microscope picture is shown in FIG. 4.

### Comparative Example 2

Based on Embodiment 1, a difference is that an adopted end-capping reagent is commercially available tetramethyl dialkylene siloxane, and an initiator is tetramethyl ammonium hydroxide. Fluorosilicone raw rubber with a molecular weight being 1,000,000 and a vinyl content being 0.5% is prepared.

A performance test is performed on fluorosilicone raw rubber prepared by Embodiments 1 to 4 and Comparative Examples 1 to 2, and test results are shown in Table 1.

Wherein,

### 1. Measurement of a Molecular Weight of Fluorosilicone Rubber

An intrinsic viscosity of the fluorosilicone rubber is tested by using a Ubbelohde viscometer to obtain a corresponding molecular weight, a solvent is ethyl acetate, a test temperature is 30° C., K=5.92×10⁵, and α=0.7.

### 2. Measurement of a Vinyl Content of Fluorosilicone Raw Rubber

The vinyl content is tested by using a nuclear magnetic resonance spectrometer, and deuterated tetrahydrofuran is used as a solvent.

### 3. Representation of a Structure of Cis-Fluorosilicone Raw Rubber

The structure of the cis-fluorosilicone raw rubber is represented by using a nuclear magnetic fluorine spectroscopy (deuterated acetone as a solvent), an infrared spectroscopy and a polarizing microscope.

### 4. Test Conditions of (a Tensile Strength

Reinforcement and vulcanization are performed on the fluorosilicone raw rubber by using 50 parts of a filler, then a test is performed in a room temperature, each sample is tested five times, and an average value is obtained.

TABLE 1
Table of a performance test

| | cis-D₃F | Molecular | Vinyl | Tensile |
|---|---|---|---|---|
| | content | weight | content | strength |
| | (%) | (ten thousand) | (%) | (MPa) |
| Embodiment 1 | 70 | 60 | 0.5 | 13.1 |
| Embodiment 2 | 70 | 100 | 0.5 | 13.9 |
| Embodiment 3 | 100 | 100 | 0.5 | 14.4 |
| Embodiment 4 | 20 | 100 | 0.5 | 12.2 |
| Comparative | 0 | 100 | 0.5 | 9.5 |
| Example 1 | | | | |
| Comparative | 70 | 60 | 0.5 | 8.0 |
| Example 2 | | | | |

TABLE 2
Fitting data of a nuclear magnetic resonance fluorine spectroscopy
of high cis-fluorosilicone raw rubber prepared by Embodiment 1

| Number of a | | Height ratio | Area ratio |
|---|---|---|---|
| characteristic peak | ppm | (%) | (%) |
| 1 | −69.3432 | 29 | 22 |
| 2 | −69.3510 | 22 | 18 |
| 3 | −69.3601 | 15 | 15 |
| 4 | −69.3671 | 29 | 34 |
| 5 | −69.3839 | 5 | 11 |

TABLE 3
Fitting data of a nuclear magnetic resonance fluorine spectroscopy
of fluorosilicone raw rubber prepared by Comparative Example 1

| Number of a | | Height ratio | Area ratio |
|---|---|---|---|
| characteristic peak | ppm | (%) | (%) |
| 1 | −69.3430 | 7 | 4 |
| 2 | −69.3510 | 14 | 12 |
| 3 | −69.3603 | 21 | 18 |
| 4 | −69.3676 | 28 | 27 |
| 5 | −69.3750 | 16 | 17 |
| 6 | −69.3846 | 14 | 22 |

Referring to Table 1, it may be seen from Embodiments 1 to 4 that a tensile strength of the cis-fluorosilicone rubber prepared by the present disclosure is not less than 12 Mpa. Upon comparison, Embodiment 2 differs from Comparative Example 1 in that in a preparation process of the present disclosure, 70% of cis-D₃F is adopted, but trans-D₃F is adopted in Comparative Example 1, and it may be seen that the tensile strength of the cis-fluorosilicone rubber in the present disclosure is improved by 38%. The fluorosilicone rubber with high isotacticity prepared by the present disclosure has good mechanical properties. Upon comparison, Embodiment 1 differs from Comparative Example 2 in that in the preparation process of the present disclosure, a self-made initiator and end-capping reagent are adopted, a commercially available initiator and end-capping reagent are adopted in Comparative Example 2, and the commercially available initiator and end-capping reagent affect an end-capping effect during a polymerization process and further affect the mechanical properties of the rubber.

FIG. 1 is a nuclear magnetic resonance fluorine spectroscopy diagram and a peak-differentiating and imitating result of the cis-fluorosilicone raw rubber prepared by Embodiment 1 of the present disclosure, and FIG. 2 is a nuclear magnetic resonance fluorine spectrum and a peak-differentiating and imitating result of the common fluorosilicone raw rubber prepared by Comparative Example 1 of the present disclosure. Referring to FIG. 1 and FIG. 2, it may be seen that the cis-fluorosilicone raw rubber prepared by the present disclosure has a nuclear magnetic resonance fluorine spectrum with a different peak shape from the common and commercially available fluorosilicone raw rubber, in the peak-differentiating and imitating results of FIG. 1 and FIG. 2, a nuclear magnetic resonance peak at a chemical shift −69.3400 ppm-69.3601 ppm is a characteristic peak of a cis-methyl trifluoropropyl siloxane structure in the fluorosilicone raw rubber, and a nuclear magnetic resonance peak at a chemical shift −69.3603 ppm-69.3839 ppm is a characteristic peak of a trans-methyl trifluoropropyl siloxane structure in the fluorosilicone raw rubber. Referring to the fitting data of Table 2, it may be calculated that in FIG. 1, a sum of areas of characteristic peaks of the cis-methyl trifluoropropyl siloxane structure in the cis-fluorosilicone raw rubber prepared by the present disclosure accounts for 55% of an area of all characteristic peaks, which is greater than 50%, and thus the cis-fluorosilicone raw rubber is high cis-fluorosilicone raw rubber; and in FIG. 2, in the commercially available fluorosilicone raw rubber, as shown by the fitting data in Table 3, a sum of areas of characteristic peaks of the cis-methyl trifluoropropyl siloxane structure accounts for 16% of an area of all characteristic peaks, which is less than 20%, and thus the commercially available fluorosilicone raw rubber is fluorosilicone raw rubber which is mainly of a trans structure. Besides, in the high cis-fluorosilicone raw rubber prepared by the present disclosure in FIG. 1, a sum of strengths of the characteristic peaks of the cis-methyl trifluoropropyl siloxane structure accounts for 66% of a strength of all the characteristic peaks; and in FIG. 2, in the commercially available fluorosilicone raw rubber, a sum of strengths of the characteristic peaks of the cis-methyl trifluoropropyl siloxane structure accounts for 21% of a strength of all the characteristic peaks. To sum up, these results indicate that the fluorosilicone raw rubber prepared by the present disclosure is fluorosilicone raw rubber with high isotacticity.

FIG. 3 is a polarizing microscope diagram of the fluorosilicone raw rubber with high isotacticity prepared by Embodiment 1 of the present disclosure, and FIG. 4 is a polarizing microscope diagram of the common fluorosilicone raw rubber prepared by Comparative Example 1 of the present disclosure. As shown in FIG. 3, a polarizing microscope picture of the high cis-fluorosilicone raw rubber prepared by the present disclosure shows Maltese cross extinction, and the phenomenon of Maltese cross extinction can prove that the product is a polymer with a crystal and thus prove that the fluorosilicone raw rubber prepared by the present disclosure is raw rubber which is mainly of the cis-methyl trifluoropropyl siloxane structure. As shown in FIG. 4, the common commercially available trans raw rubber has no phenomenon of Maltese cross extinction, which proves that the common commercially available trans raw rubber is a polymer without crystals and thus proves that the commercially available fluorosilicone raw rubber is raw rubber which is mainly of the trans-methyl trifluoropropyl siloxane structure.

In an exemplary embodiment of the present disclosure, a high-strength oil-resistant fluorosilicone sealing material for an engine includes, by weight, the following raw materials:
100 parts of fluorosilicone raw rubber with high isotacticity, 5 parts to 60 parts of a reinforcing filler and 0.5 parts to 4 parts of a vulcanizing agent.

A content of a cis-methyl trifluoropropyl siloxane structure in the fluorosilicone raw rubber with high isotacticity is not less than 20%. High cis in the fluorosilicone raw rubber with high isotacticity refers to that a proportion for which the number of chain links of three connected methyl trifluoropropyl siloxane with the same stereoscopic configuration accounts of the total number of chain links is greater than 20%, or a proportion for which the number of chain links of two adjacent methyl trifluoropropyl siloxane with the same stereoscopic configuration accounts of the total number of chain links is greater than 50%. Further, the content of the cis-methyl trifluoropropyl siloxane structure in the fluorosilicone raw rubber with high isotacticity is not less than 30%, preferably, the content of the cis-methyl trifluoropropyl siloxane structure in the fluorosilicone raw rubber with high isotacticity is not less than 50%, and more preferably, the content of the cis-methyl trifluoropropyl siloxane structure in the fluorosilicone raw rubber with high isotacticity is not less than 80%.

The reinforcing filler may be one or more of white carbon black, carbon black, graphene, gypsum fiber, carbon fiber, organic clay and boron nitride. Preferably, the reinforcing filler is 15 parts to 40 parts. The vulcanizing agent may be a peroxide vulcanizing agent. Preferably, the vulcanizing agent is 2,5-dimethyl-2,5-Di-tert-butyl hexane peroxide (bis 2,5 for short), and the vulcanizing agent is 1 part to 3.5 parts.

Specifically, a structural formula of the fluorosilicone raw rubber with high isotacticity is as follows.

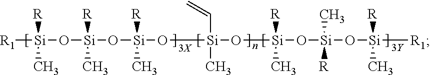

wherein R is —CH₂CH₂CF₃, R₁ is one of hydroxyl, methyl and vinyl, X/(X+Y)=0-1, and n/(3X+3Y+n)=0-5%; and a molecular weight is 200,000 to 1,500,000.

Further, X/(X+Y)=0.15-0.8; and preferably, X/(X+Y)=0.3-0.6.

Further, n/(3X+3Y+n)=0.2-4%; and preferably, n/(3X+3Y+n)=1-3%.

Further, a molecular weight is 400,000 to 1,000,000, and preferably, the molecular weight is 500,000 to 800,000.

Specifically, a method for preparing a high-strength oil-resistant fluorosilicone sealing material includes: fluorosilicone raw rubber with high isotacticity and a reinforcing filler are mixed uniformly according to a corresponding proportion, then a vulcanizing agent is added and uniformly dispersed, and then forming is performed through first-stage vulcanization and second-stage vulcanization.

A temperature in the first-stage vulcanization ranges from 140° C. to 180° C., and a temperature in the second-stage vulcanization ranges from 140° C. to 220° C. Preferably, the temperature in the first-stage vulcanization ranges from 150° C. to 170° C., and the temperature in the second-stage vulcanization ranges from 160° C. to 200° C.

In another exemplary embodiment of the present disclosure, the raw materials further include one or more of other rubber, a compatilizer and a heat resisting agent.

By weight, the other rubber is 0 to 20 parts, the compatilizer is 0 to 5 parts, and the heat resisting agent is 0 to 10 parts.

Specifically, the other rubber may be one or more of hydrogenated butadiene-acrylonitrile rubber, nitrile rubber, chloroprene rubber, fluororubber, butadiene styrene rubber, chlorinated butyl rubber, natural rubber, methyl phenyl silicone rubber and dimethyl silicone rubber. Preferably, the other rubber is 5 parts to 10 parts.

The compatilizer may be one of perfluorodecyltrimethoxysilane, trifluoropropyl trimethoxy silane, and methyl trifluoropropyl dimethoxysilane. Preferably, the compatilizer is 2 parts to 4 parts.

The heat resisting agent may be one or more of graphene oxide, Fe₂O₃, Al₂O₃, CeO₂, La₂O₃, Sm₂O₃, Gd₂O₃ and Dy₂O₃; and preferably, the heat resisting agent is Fe₂O₃ and is 3 parts to 7 parts.

Specifically, the method for preparing the high-strength oil-resistant fluorosilicone sealing material includes: the fluorosilicone raw rubber with high isotacticity, the other rubber, the compatilizer and the reinforcing filler are mixed uniformly according to a corresponding proportion. For example, uniform mixing may be performed in an internal mixer, then the vulcanizing agent is added on an open mill and uniformly dispersed, and then forming is performed through first-stage vulcanization and second-stage vulcanization. The first-stage vulcanization is performed for 5 min to 40 min in a temperature ranging from 140° C. to 180° C. for the main purpose of shaping vulcanization, too much crosslinking occurs if the temperature is higher than 180° C., and incomplete vulcanization occurs if the temperature is lower than 140° C., thereby affecting a size of a product. The second-stage vulcanization is performed for 1 h to 6 h in a temperature ranging from 140° C. to 220° C. for the main purpose of removing volatile matter in a product and completing crosslinking, the volatile matter is difficult to remove if the temperature is lower than 140° C., and aging of the product occurs if the temperature is higher than 220° C.

### Embodiment 5

A high-strength oil-resistant fluorosilicone sealing material for an engine includes, by weight, the following raw materials: 100 parts of fluorosilicone raw rubber with high isotacticity, 50 parts of a reinforcing filler, namely white carbon black, and 2 parts of a bis 2,5 vulcanizing agent.

A content of a cis-methyl trifluoropropyl siloxane structure in the fluorosilicone raw rubber with high isotacticity is 70%.

The method for preparing the high-strength oil-resistant fluorosilicone sealing material for the engine includes: 1 kg of the fluorosilicone raw rubber with high isotacticity is added into an open mill, 500 g of the reinforcing filler is added separately three times, and uniform mixing is performed in a temperature of lower than 60° C. to obtain a rubber compound; 20 g of the bis 2,5 vulcanizing agent is added into the rubber compound on a two-roll open mill for thin passing many times; and placing is performed for 24 h in a room temperature, then the first-stage vulcanization is performed for 20 min in a vulcanization temperature of 170° C. and a vulcanization pressure of 10 MPa on a vacuum vulcanizing machine, and finally, the second-stage vulcanization is performed for 4 h in a blasting oven of 180° C. to obtain the fluorosilicone sealing material.

### Embodiment 6

A high-strength oil-resistant fluorosilicone sealing material for an engine includes, by weight, the following raw materials: 100 parts of fluorosilicone raw rubber with high isotacticity, 30 parts of a reinforcing filler, namely white carbon black, and 3 parts of a bis 2,5 vulcanizing agent.

A content of a cis-methyl trifluoropropyl siloxane structure in the fluorosilicone raw rubber with high isotacticity is 70%.

The method for preparing the high-strength oil-resistant fluorosilicone sealing material for the engine includes: 1 kg of the fluorosilicone raw rubber with high isotacticity is added into an open mill, 300 g of the reinforcing filler is added separately three times, and uniform mixing is performed in a temperature of lower than 60° C. to obtain a rubber compound; 30 g of the bis 2,5 vulcanizing agent is added into the rubber compound on a two-roll open mill for thin passing many times; and placing is performed for 24 h in a room temperature, then the first-stage vulcanization is performed for 30 min in a vulcanization temperature of 180° C. and a vulcanization pressure of 10 MPa on a vacuum vulcanizing machine, and finally, the second-stage vulcanization is performed for 4 h in a blasting oven of 200° C. to obtain the fluorosilicone sealing material.

### Embodiment 7

A high-strength oil-resistant fluorosilicone sealing material for an engine includes, by weight, the following raw materials: 100 parts of fluorosilicone raw rubber with high isotacticity, 4 parts of a compatilizer, 10 parts of nitrile rubber, 50 parts of a reinforcing filler, namely fumed silica, and 3 parts of a bis 2,5 vulcanizing agent.

A content of a cis-methyl trifluoropropyl siloxane structure in the fluorosilicone raw rubber with high isotacticity is 70%.

The method for preparing the high-strength oil-resistant fluorosilicone sealing material for the engine includes: 1 kg of the fluorosilicone raw rubber with high isotacticity is added into an open mill, 500 g of the fumed silica is added separately three times, and uniform mixing is performed in a temperature of lower than 60° C. to obtain a first rubber compound; then 40 g of the compatilizer and 100 g of the nitrile rubber are added for internal mixing in an internal mixer to obtain a second rubber compound, and 30 g of the bis 2,5 vulcanizing agent is added into the second rubber compound on a two-roll open mill for thin passing many times; and placing is performed for 24 h in a room temperature, then first-stage vulcanization is performed for 30 min in a vulcanization temperature of 180° C. and a vulcanization pressure of 40 MPa on a vacuum vulcanizing machine, and finally, second-stage vulcanization is performed for 6 h in a blasting oven of 180° C. to obtain the fluorosilicone sealing material.

### Embodiment 8

Based on Embodiment 5, a difference is that 10 parts of a heat resisting agent and 3 parts of a vulcanizing agent are added additionally.

### Embodiment 9

Based on Embodiment 5, a difference is that a content of a cis-methyl trifluoropropyl siloxane structure in fluorosilicone raw rubber with high isotacticity is 40%.

### Embodiment 10

Based on Embodiment 5, a difference is that a content of a cis-methyl trifluoropropyl siloxane structure in fluorosilicone raw rubber with high isotacticity is 20%, a reinforcing filler is 50 parts, and a vulcanizing agent is 0.5 parts.

### Comparative Example 3

Based on Embodiment 5, a difference is that adopted commercially available common fluorosilicone raw rubber has a molecular weight of 1,000,000 and a vinyl content of 0.3%.

### Comparative Example 4

Based on Comparative Example 3, a difference is that 20 parts of nitrile rubber, 4 parts of a compatilizer and 3 parts of a bis 2,5 vulcanizing agent are added additionally.

Proportions of Embodiments 5 to 10 and Comparative Examples 3 to 4 are listed in Table 4, and performance test results of the prepared fluorosilicone sealing material are listed in Table 5.

The mechanical properties of the material are tested at a speed of 500 mm/min on an electronic universal testing machine according to a national standard GB/T-528-2009, a parallel experiment is performed on each sample five times, and an average value is obtained.

Oil resistance of the material is tested according to a national standard GB/T1690-2006, resistance to 2 #standard oil is tested, and a test condition is: 150° C.×70 h.

TABLE 4
Table of proportions

| | A content/% | Fluorosilicone | | | | | |
|---|---|---|---|---|---|---|---|
| | of a cis-methyl | raw rubber | | | | | |
| | trifluoropropyl | molecular | Other | | | Heat | |
| | siloxane | weight/ten | rubber/ | Compatilizer/ | Reinforcing | resisting | Vulcanizing |
| | structure | thousand | parts | parts | filler/parts | agent/parts | agent/parts |
| Embodiment 5 | 70 | 100 | 0 | 0 | 50 | 0 | 2 |
| Embodiment 6 | 70 | 100 | 0 | 0 | 30 | 0 | 3 |
| Embodiment 7 | 70 | 100 | 10 | 4 | 50 | 0 | 3 |
| Embodiment 8 | 70 | 100 | 0 | 0 | 50 | 10 | 3 |
| Embodiment 9 | 40 | 100 | 0 | 0 | 50 | 0 | 2 |
| Embodiment 10 | 20 | 100 | 0 | 0 | 50 | 0 | 0.5 |
| Comparative | 0 | 100 | 0 | 0 | 50 | 0 | 3 |
| Example 3 | | | | | | | |
| Comparative | 0 | 100 | 20 | 4 | 50 | 10 | 3 |
| Example 4 | | | | | | | |

TABLE 5
Performance test

| | | | Permanent | Oil resistance- | Oil resistance- |
|---|---|---|---|---|---|
| | | | compression | tensile strength | breaking elongation |
| | Tensile | Breaking | set value/ | (2# standard | (2# standard |
| | strength/ | elongation/ | (150° C. × | oil, 150° C. × | oil, 150° C. × |
| | MPa | % | 70 h, %) | 70 h, MPa) | 70 h, %) |
| Embodiment 5 | 14.9 | 389 | 9.5 | 13.4 | 300 |
| Embodiment 6 | 14.4 | 368 | 9.3 | 13.1 | 310 |
| Embodiment 7 | 16.5 | 356 | 15.2 | 11.5 | 320 |
| Embodiment 8 | 15.2 | 370 | 12.3 | 13.9 | 302 |
| Embodiment 9 | 13.4 | 370 | 9.8 | 12.1 | 300 |
| Embodiment 10 | 13.2 | 365 | 9.8 | 11.8 | 295 |
| Comparative | 10.6 | 378 | 10.5 | 8.8 | 290 |
| Example 3 | | | | | |
| Comparative | 12.6 | 350 | 30.4 | 7.2 | 200 |
| Example 4 | | | | | |

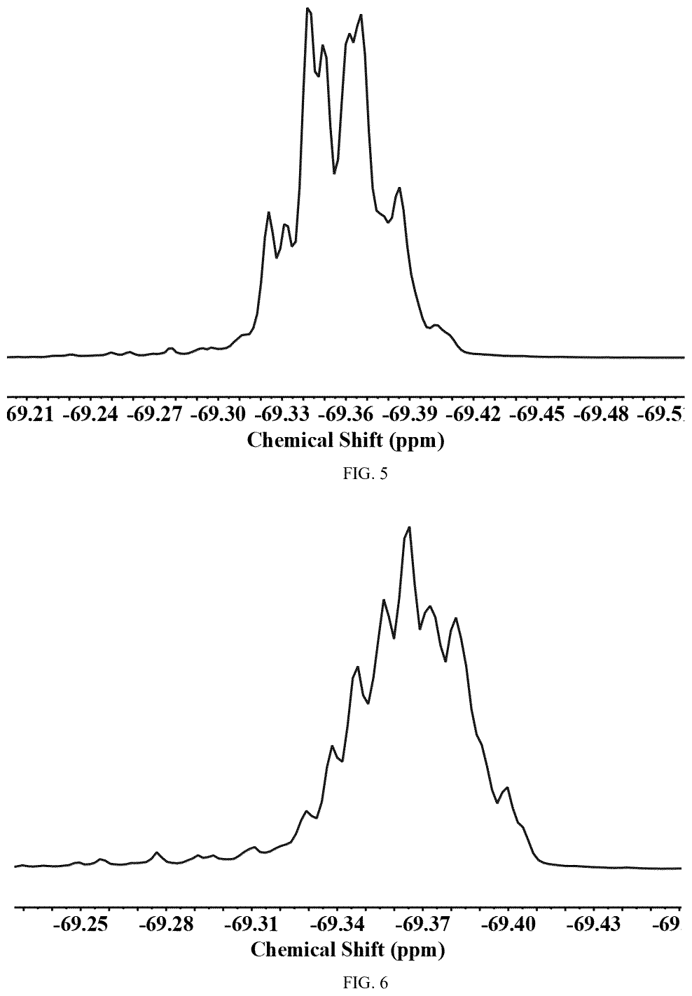

FIG. 5 shows a nuclear magnetic resonance fluorine spectrum of fluorosilicone raw rubber of Embodiment 5 of the present disclosure. FIG. 6 shows a nuclear magnetic resonance fluorine spectrum of fluorosilicone raw rubber in Comparative Example 3. Referring to FIG. 5 and FIG. 6, it may be seen that the high cis-fluorosilicone raw rubber prepared by the present disclosure has a nuclear magnetic resonance fluorine spectrum with a different peak shape from common and commercially available fluorosilicone raw rubber, in FIG. 5, a nuclear magnetic resonance peak at a chemical shift −69.3400 ppm-69.3601 ppm is a characteristic peak of a cis-methyl trifluoropropyl siloxane structure in the fluorosilicone raw rubber, and in FIG. 6, a nuclear magnetic resonance peak at a chemical shift −69.3603 ppm-69.3839 ppm is a characteristic peak of a trans-methyl trifluoropropyl siloxane structure in the fluorosilicone raw rubber.

Referring to Table 4, it may be seen from Embodiments 5, 6, 9 and 10 that the fluorosilicone raw rubber with high isotacticity used by the present disclosure has a tensile strength of not less than 13 Mpa, a permanent compression set value of not higher than 10% and a breaking elongation of not less than 360%, which indicates that the fluorosilicone sealing material prepared by the present disclosure has an excellent mechanical strength.

Upon comparison, Embodiment 5 mainly differs from Comparative Example 3 in that Embodiment 5 adopts the fluorosilicone raw rubber with high isotacticity, but Comparative Example 3 adopts commercially available fluorosilicone raw rubber, and the commercially available fluorosilicone raw rubber is of a trans-methyl trifluoropropyl siloxane structure. It may be seen that the tensile strength of the fluorosilicone sealing material prepared by the present disclosure is improved by 41%, the breaking elongation is improved by 3%, and the permanent compression set value is reduced by 9.5%. In the present disclosure, soaking is performed in 2 #standard oil for 70 h in 150° C., then the measured tensile strength is improved by 52%, and the measured breaking elongation is improved by 3.4%.

By comparing Embodiment 5 with Embodiment 10, it may be seen that the higher the content of the cis-methyl trifluoropropyl siloxane structure in the fluorosilicone raw rubber, the better the mechanical properties and oil resistance of the prepared fluorosilicone sealing material.

A main difference between Comparative Example 3 and Comparative Example 4 is that the other rubber and the compatilizer are added additionally in Comparative Example 4. It may be seen that in Comparative Example 4, though the tensile strength is improved, the breaking elongation and the permanent compression set value of the material are reduced. Besides, the oil resistance of the material is reduced.

A main difference between Embodiment 7 and Embodiment 5 is that another type of high-strength rubber and the compatilizer are added in Embodiment 7, and it may be seen that the tensile strength is improved by 11%, and the breaking elongation and the permanent compression set value are mildly reduced. Soaking is performed in 2 #standard oil for 70 h in 150° C., then the measured tensile strength is reduced by 14%, and the measured breaking elongation is improved by 6.7%. It indicates that though the tensile strength is improved by blending with the other rubber, the oil resistance of the material is reduced to a certain degree.

By comparing Embodiment 7 and Comparative Example 4, after being blended with the another type of high-strength rubber, the tensile strengths of the both are improved, however, for the fluorosilicone sealing material prepared by the present disclosure, the tensile strength may be improved from 14.9 MPa to 16.5 MPa only by being blended with 10 parts of nitrile rubber, and it may be known form Comparative Example 2 that more high-strength rubber is needed if the tensile strength is expected to be improved by the equivalent degree. Besides, due to the problem of poor compatibility between the fluorosilicone rubber and the high-strength rubber, adding too much high-strength rubber may cause phase separation, and thus the oil resistance of the material is reduced.

A main difference between Embodiment 8 and Embodiment 5 is that 10 parts of the heat resisting agent is added additionally in Embodiment 8. It may be seen that the mechanical properties are improved, as the heat resistance of the material is improved, the oil resistance of the material is also mildly improved when the material is soaked in 2 #standard oil of 150° C.

To sum up, the common fluorosilicone rubber needs addition of more other rubber to improve its mechanical strength, but in this case, the oil resistance is reduced greatly, however, the fluorosilicone raw rubber with high isotacticity used by the present disclosure has good own mechanical properties, and may achieve the excellent mechanical properties without adding more or less other rubber, and meanwhile, the oil resistance is hardly affected.

The foregoing descriptions are merely embodiments of the present disclosure and are not intended to limit the present disclosure. There may be various modifications and changes of the present disclosure to those skilled in the art. Any modification, equivalent replacement, improvement or the like made within the spirit and principle of the present disclosure shall fall within the scope of the claims of the present disclosure.

What is claimed is:

1. A fluorosilicone raw rubber with a high isotacticity, wherein a structural formula of the fluorosilicone raw rubber with the high isotacticity is as follows: 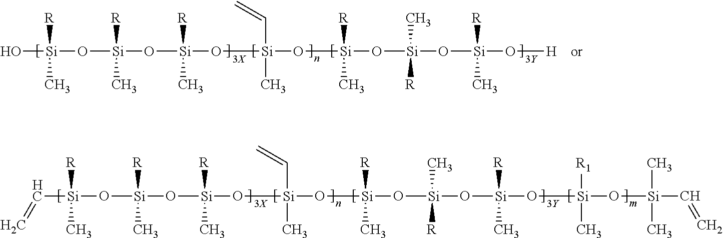
wherein R is trifluoropropyl, R₁ is one or more of phenyl, vinyl, and trifluoropropyl, m=2-10, 0<X/(X+Y)<1, and n/(X+Y)=0-10%; and
a content of a cis-methyl trifluoropropyl siloxane structure is not less than 20%, and a content of a vinyl siloxane chain link ranges from 0 to 50%.

2. The fluorosilicone raw rubber with the high isotacticity according to claim 1, wherein the content of the cis-methyl trifluoropropyl siloxane structure is not less than 50%.

3. The fluorosilicone raw rubber with the high isotacticity according to claim 1, wherein a molecular weight of the fluorosilicone raw rubber with the high isotacticity is not less than 1,000.

4. The fluorosilicone raw rubber with the high isotacticity according to claim 1, wherein the content of the vinyl siloxane chain link of the fluorosilicone raw rubber with the high isotacticity ranges from 10% to 40%.

5. A method for preparing the fluorosilicone raw rubber with the high isotacticity according to claim 1, comprising:
adding an end-capping reagent, an initiator, a vinyl cyclic, and an accelerant into 1,3,5-tris-(3,3,3-trifluoropropyl)methylcyclotrisiloxane (D₃F) for a polymerization reaction, wherein cis-1,3,5-tris-(3,3,3-trifluoropropyl)methylcyclotrisiloxane (cis-D₃F) in the D₃F has a content not less than 20%, and then adding a neutralizer in sequence for removing volatile components to obtain the fluorosilicone raw rubber with the high isotacticity;
wherein a mass ratio of the D₃F to the end-capping reagent to the initiator to the vinyl cyclic to the accelerant to the neutralizer is 10000:(0-100):(1-100):(0-2000):(0-1):(1-100).

6. The method according to claim 5, wherein a method for preparing the end-capping reagent comprises: mixing a siloxane cyclic, a vinyl end-capping reagent, and an alkali metal catalyst, then dehydrating, heating to a range from 60° C. to 120° C., and then removing, by a decompression, unreacted small molecules and a by-product to obtain the end-capping reagent;
wherein a mass ratio of the siloxane cyclic to the vinyl end-capping reagent to the alkali metal catalyst is 2500:(650-1500):(1-2).

7. The method according to claim 5, wherein a method for preparing the initiator comprises: mixing an alkali metal hydroxide and/or a basic hydroxide and a siloxane cyclic, then dehydrating, heating to a range from 80° C. to 180° C. for a reaction, and then removing, by a decompression, volatile components to obtain the initiator;
wherein a mass ratio of the alkali metal hydroxide and/or the basic hydroxide to the siloxane cyclic is (0.1-10):100.

8. The method according to claim 5, wherein the vinyl cyclic is a cyclic mixture of trimethyl trivinyl cyclotrisiloxane, tetramethyl tetravinyl cyclotetrasiloxane, methyl vinyl, and methyl trifluoropropyl.

9. The method according to claim 5, wherein the neutralizer is one or more of formic acid, acetic acid, silica-based phosphate, fluorosilicone-based phosphate, or CO₂.

10. The method according to claim 5, wherein a temperature in the polymerization reaction ranges from 80° C. to 180° C.

11. A high-strength oil-resistant fluorosilicone sealing material for an engine, in parts by weight, comprising:
100 parts of a fluorosilicone raw rubber with a high isotacticity, 5 parts to 60 parts of a reinforcing filler, and 0.5 parts to 4 parts of a vulcanizing agent;
wherein a content of a cis-methyl trifluoropropyl siloxane structure in the fluorosilicone raw rubber with the high isotacticity is not less than 20%.

12. The high-strength oil-resistant fluorosilicone sealing material according to claim 11, wherein a structural formula of the fluorosilicone raw rubber with the high isotacticity is as follows: 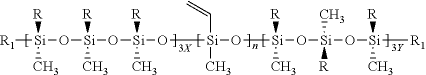
wherein R is —CH₂CH₂CF₃, R₁ is one of hydroxyl, methyl, and vinyl, X/(X+Y)=0-1, n/(3X+3Y+n)=0-5%, and a molecular weight of the fluorosilicone raw rubber with the high isotacticity is 200,000 to 1,500,000.

13. The high-strength oil-resistant fluorosilicone sealing material according to claim 11, wherein the content of the cis-methyl trifluoropropyl siloxane structure in the fluorosilicone raw rubber with the high isotacticity is not less than 30%.

14. The high-strength oil-resistant fluorosilicone sealing material according to claim 11, further comprising one or more of 0 to 20 parts by weight of an other rubber, 0 to 5 parts by weight of a compatilizer, and 0 to 10 parts by weight of a heat resisting agent.

15. The high-strength oil-resistant fluorosilicone sealing material according to claim 14, wherein the other rubber is one or more of a hydrogenated butadiene-acrylonitrile rubber, a nitrile rubber, a chloroprene rubber, a fluororubber, a butadiene styrene rubber, a chlorinated butyl rubber, a natural rubber, a methyl phenyl silicone rubber, and a dimethyl silicone rubber.

16. The high-strength oil-resistant fluorosilicone sealing material according to claim 11, wherein the reinforcing filler is one or more of white carbon black, carbon black, graphene, gypsum fiber, carbon fiber, organic clay, and boron nitride.

17. The high-strength oil-resistant fluorosilicone sealing material according to claim 14, wherein the heat resisting agent is one or more of graphene oxide, Fe₂O₃, Al₂O₃, CeO₂, La₂O₃, Sm₂O₃, Gd₂O₃, and Dy₂O₃.

18. The high-strength oil-resistant fluorosilicone sealing material according to claim 14, wherein the compatilizer is one of perfluorodecyltrimethoxysilane, trifluoropropyl trimethoxy silane, and methyl trifluoropropyl dimethoxysilane.

19. A method for preparing the high-strength oil-resistant fluorosilicone sealing material according to claim 11, comprising:
uniformly mixing the fluorosilicone raw rubber with the high isotacticity and the reinforcing filler according to a corresponding ratio, then adding the vulcanizing agent, performing a uniform dispersion, and then performing forming through a first-stage vulcanization and a second-stage vulcanization;
wherein a temperature in the first-stage vulcanization ranges from 140° C. to 180° C., and a temperature in the second-stage vulcanization ranges from 140° C. to 220° C.

20. The method according to claim 19, wherein the temperature in the first-stage vulcanization ranges from 150° C. to 160° C., and the temperature in the second-stage vulcanization ranges from 160° C. to 200° C.
